(19) United States
(12) Patent Application Publication
(10) Pub. No.: US 2009/0055317 A1
(43) Pub. Date: Feb. 26, 2009

(54) Method and System of Distributing and Activating Storage Value Cards

(76) Inventors: A. Hamid Andalib, Chattanooga, TN (US); Jeffrey W. Grine, Chattanooga, TN (US); Brad J. Smrcina, Chattanooga, TN (US); David Barber, Chattanooga, TN (US); Greg A. Jones, Chattanooga, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/843,130

(22) Filed: Aug. 22, 2007

(51) Int. Cl. G06Q 30/00

(52) U.S. Cl. 705/41; 235/380; 705/14

(57) ABSTRACT

A method of distributing stored value cards where value is not loaded to the account associated with each card until the card holder completes and activates process is disclosed. By delaying the funding of the settlement account associated with stored value cards until card activation, cash flow efficiencies and savings are achieved that make stored value card rebate plans and other marketing and loyalty programs economical.

### FIELD OF THE INVENTION

The present invention generally relates to stored value cards such as bank debit cards and more particularly to the timing of assigning value to the accounts associated with stored value cards and the use of stored value cards in a corporate incentive program.

### BACKGROUND OF THE INVENTION

Many businesses have a need to make small monetary payments to consumers with whom they do not enjoy an electronic banking relationship. The default method of making such payments is by check. Thus, for example, when a consumer qualifies for a rebate or is entitled to a refund, they are provided with a coupon to be used to claim their refund or rebate. After the coupon is submitted, the refund or rebate is frequently transmitted by mailing a check in the appropriate amount to the consumer. Businesses have recognized that it may be advantageous to make such payments utilizing a stored value or gift card.

These stored value cards are generally prefunded cards, storing cash value and in some instances the value on the cards may even be replenished. Visa, MasterCard and many retailers offer such stored value cards as gift cards. Another typical use of these stored value cards involves a consumer qualifying for a rebate or refund. In this case, the company giving the rebate or refund pays for the creation of a stored value card, the value is loaded on or assigned to the card, the card is mailed to the consumer, the consumer activates the card upon receipt and the consumer spends the value of the card account.

The use of stored value cards provides many benefits over merely mailing a check, as the stored value card provides an opportunity both for branding, and for collecting information regarding customer purchases utilizing the stored value card. However, two significant shortcomings exist in the current stored value card system. First, it is necessary that the company advance the value of the rebate or refunds when the value is loaded to the account of a stored value card. This requires the payment of funds into a settlement account, often several weeks before the consumer is ready to utilize the stored value card to make a purchase. The second shortcoming is that once funds are loaded to the stored value card account, those funds may become assets subject to escheatment under state abandoned property laws. Thus, funds paid in consumer refunds and rebates may escheat to the state rather than being effectively used in customer marketing and retention programs. What is needed is a system and method that makes it easier and more attractive to businesses to utilize stored value cards for consumer transactions.

### SUMMARY OF THE INVENTION

One embodiment of the present invention comprises a method for providing rebates utilizing stored value cards where value is loaded to the card only after the card has been received and activated by the consumer. Accordingly, the rebate process typically includes steps of the consumer making a qualified purchase, the consumer submitting the necessary rebate information usually in the form of a coupon provided by the company, rebate information being processed, a stored value rebate card being issued and transmitted to the consumer, the consumer following a card activation process, value being loaded to the account associated with the stored value card only contemporaneous with or subsequent to this activation process, and finally, the consumer utilizing the stored value card to make purchases.

According to this method, the consumer receives a rebate or refund coupon when purchasing a product or service. The company offering the rebate or refund only pays a card fee at the time the stored value card is issued. The stored value card operates as a secondary coupon because the actual value of the rebate is not loaded to the stored value card until activation. This process saves the company typically between about 5-30 days cash flow. Time periods for state abandoned property laws do not commence until the card is activated and value loaded to the card. Card fees that might diminish the value of a rebate to consumer do not begin until after activation. Perhaps most importantly, the company offering the rebate is able to save the funds that would have previously been loaded to stored value cards that were never activated. These funds would have previously subject to card fees or escheat laws, but now can be retained for other marketing and loyalty programs.

This method provides the rebate offering company with all of the security that can be implemented through typical stored value card operations, as one administered by Visa or MasterCard systems, advertising on the stored value card to enhance consumer branding, cash flow savings from delays in loading value to stored value cards, collection of customer specific data from use of stored value cards, and the avoidance of escheats from abandoned property laws from loaded value on stored value cards that are never activated by consumers. Similar benefits when providing stored value cards as gifts, other promotions, or customer refunds, may be realized. Accordingly, a unique aspect of the invention is facilitating monetary payments utilizing stored value cards whose funds are loaded only upon card activation.

### BRIEF DESCRIPTION OF THE DRAWINGS

The invention will be better appreciated with reference to the appended drawings in which like reference characters are used to indicate like elements and in which:

FIG. 1 is a flow diagram depicting communications between participants in all exemplary rebate programs.

FIG. 2A is a flow diagram of a typical prior art rebate process with payment by check.

FIG. 2B is a flow diagram of a typical prior art rebate process with payment by a stored value card.

FIG. 2C is a flow diagram of a typical rebate process with a “load on activation.”

FIG. 3 is a more detailed flow diagram of another exemplary rebate process utilizing a loaded value upon activation procedure as disclosed in the present invention.

### DETAILED DESCRIPTION OF THE INVENTION

Stored value cards (Visa and MasterCard Debit Cards) normally carry a one-time load value and this value is added to the account associated with the card at the time the card is created. The new method allows for the load value to be added at the time of activation. This creates a non-value of all cards issued but not yet activated giving the issuing entity certain escheatment and financial benefits.

Stored value cards are frequently issued in two fashions:

(1) Consumer Redemption or Purchase Option. In one fashion, consumers purchase a stored value card directly. The stored value card may be restricted to use in a single retail establishment or chain, or may be accepted broadly as in the case of Visa and MasterCard debit cards. An alternative method of consumer redemption involves awarding consumers vouchers, where the voucher holder may redeem the voucher for any one of a number of options including merchant cards, vacations, experience packages and stored value cards.

(2) Direct Business Sales. Stored value products are also sold directly to the businesses. This type of distribution may or may not take place within some other loyalty or incentive system (i.e., a points program or sale of cards for one-time sales incentives such as rebates).

Generally speaking the existing industry practice of loading stored value cards is that the value is added to the card account at the time where the card is issued (Personalized Single Use Issuance) or instantly at the time in which the card is purchased at a retailer (Non-personalized Instant Issue Cards). Industry practices for these cards and card activation are summarized as follows:

Card Activation. The normal process involved in the receipt of cards (normally a single use or re-loadable card) involves a user calling or going online to confirm receipt of and acceptance of the card and the terms and conditions of its use. The card is then “Activated” by the processor and the card is ready for use. The activation process is normally communicated to the user by a sticker on the front of the card and instructions printed on the card carrier.

Personalized Single Use Issuance. The issuance of cards to the end cardholder for single use (one-time load value with potentially multiple purchases ending in the card being destroyed) is sometimes personalized where the card includes the cardholder's name embossed on the face and the account includes standard information on the cardholder such as name, address and phone number. The card value is loaded to the card account at the time the card is fulfilled from the card processor.

Non-personalized Instant Issue Cards. The issuance of non-personalized cards normally takes place at physical locations such as a mall, banks and credit unions. These cards are not personalized (general name on the card such as “Preferred Cardholder” or “XYZ Bank Customer”) and a limited amount of information may or may not be collected from the cardholder and added to the account. The load value is collected from the purchaser and “instantly” transferred to the account accessed by the card.

Other Industry Practices. Programs such as re-loadable cards, payroll cards or travel cards, teen cards and reimbursement cards all receive load value to the account accessed by the card on an ongoing basis throughout the life of the card/account.

Loading the dollar value to accounts accrued by single use issuance stored value cards at the time where the card activation takes place improves upon the methodologies currently being employed. This method results in the card and its account having no dollar value until the party receiving the card has accepted and activated the card, including any terms that the acceptance may require.

By way of example, assume a wireless telecommunications company is in need of a rebate Visa debt card to issue rebates on cell phone equipment purchases. The wireless telecommunications company has some experience in issuing rebate Visa stored value cards. However, the cost of utilizing Visa and MasterCard Debt Cards is greater than merely mailing a check, and the benefits from the increased consumer branding experience and information on consumer spending habits may not outweigh these increased costs.

According to the invention, stored value cards are utilized with card activation formulated as the last step in a multi-step process of qualifying for the rebate. This solution allows the wireless telecommunications company to participate in the breakage that occurs on the non-use of cards without concern for the escheatment issues related to unclaimed property, and thereby reduces the overall cost of the program.

Since the cards are not allotted cash value at the point in which the cards are distributed to the cardholder there is a significant cash flow advantage. This is due to the fact that the load value does not need to be dedicated to the stored value cards settlement account until card activation. Also, since the cards are not allotted cash value until the cards are activated, there is no value to escheat under typical state escheatment laws. The idea of these practices is to not challenge any of the principals of escheatment but rather avoid them.

Using the card activation as the point in which funds are essentially transferred from one party to another (Card Issuing Organization to the Cardholder) allows for the act of card activation to be included as a step in the official acceptance of the dollar value.

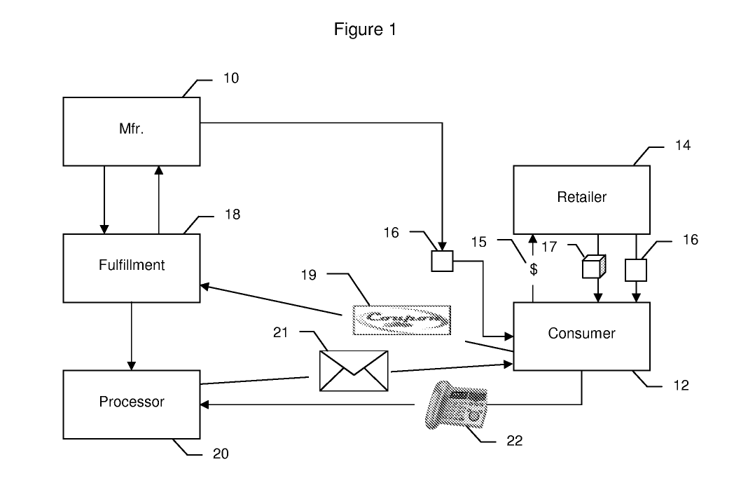

Turning then to FIG. 1, an illustration of the transaction between the various parties in a rebate situation are depicted. The process starts with a manufacturer or service provider 10 which offers a rebate 16 to consumer 12. The rebate offer 16 may be transmitted to the consumer by mail or electronically, or may be obtained by the consumer 12 in connection with the purchase from retailer 14. It will be understood that particularly in the case of consumer services, the retailer 14 and service provider 10 may be the same entity. The consumer transactions with the retailer 14 generally involve payment of money 15 for product or services 17. In connection with the transaction the retailer 14 may provide a consumer 12 with rebate information 16. Once the consumer 12 is in possession of rebate information 16 and has made a qualifying purchase, the consumer submits completed rebate information 19 to the fulfillment provider 18 engaged by manufacturer or service provider 10. It will be understood that fulfillment can be accomplished by a department of the manufacturer or service provider. In most instances, however, a separate business specializing in promotion fulfillment services is utilized.

The promotion fulfillment company 18 qualifies the rebate redemption information 19 from the consumer 12 and advises the manufacturer/service provider 10 which makes payments to the fulfillment company for at least the rebate qualification services and also makes payments either to the fulfillment company 18 or a separate processing provider 20 that mails an award 21 to the consumer 12. The award has traditionally been in the form of a check, however, in the case where the award is a stored value card, the consumer 12 will then make activation call 22 to the processor 20 as a part of the security protocols to ensure proper receipt and to minimize misuse of stored value cards.

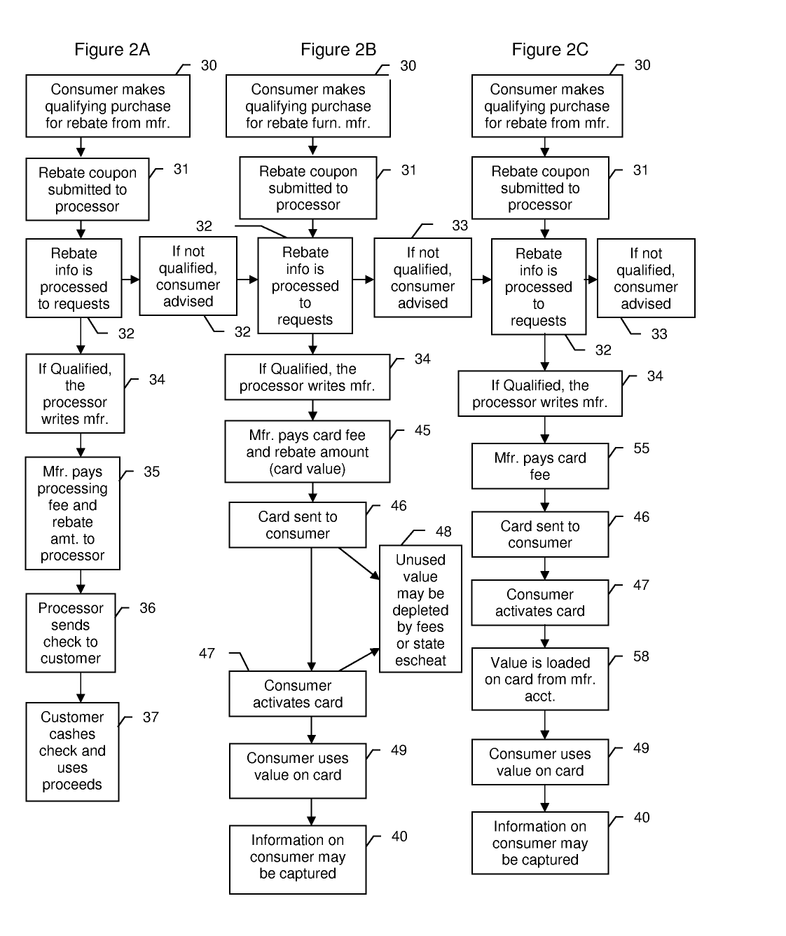

A more detailed examination of the processes utilizing checks and stored value cards are depicted in FIGS. 2A, 2B and 2C. FIG. 2A represents the steps involved in a consumer rebate program in which the consumer is issued a check. FIG. 2B discloses the steps and the process of a consumer rebate program utilizing the stored value card in the traditional model where value is located when cards are issued. FIG. 2C represents an exemplary series of steps in a consumer rebate program utilizing the load on activation feature of the present invention.

In each instance, the consumer makes qualifying purchase for the rebate 30 and then completes the rebate information and submits that information to the rebate fulfillment processor 31. It will be understood that this may be accomplished online or by mailing in the coupon to the fulfillment processor. The fulfillment processor then processes the rebate request 32 if the rebate request does not qualify, the consumer is preferably notified of the rejection 33. If the rebate request is qualified, the fulfillment processor typically notifies the manufacturer 34. The manufacturer in FIG. 2A then pays the fulfillment processor a fee for processing rebate requests and the amount that is needed for checks to be issued to consumers 35. The processor upon payment from manufacturer then sends rebate checks to qualifying consumers 36. Finally, consumers receive checks, cash checks and use the proceeds 37.

Payment by check may be less desirable than payment by stored value card for those consumers who do not enjoy free banking services, as these consumers may be charged a fee for check cashing. To avoid this drawback and to achieve the additional branding opportunity available with a manufacturer branded stored value card, and to acquire additional information regarding customer spending habits, stored value cards are utilized in some consumer rebate programs. The initial steps of known stored value card rebate programs are the same as in FIG. 2A, however, upon the manufacturer being notified of qualified rebates 34 the manufacturer then pays the fulfillment company/card processor both a card fee and the rebate amount.

The rebate amount is the load value that is assigned to the stored value cards. The cards are then generated and sent to the consumers 46. If the consumer fails to activate the card, the unused value may be depleted by the card processing company's monthly fees or by state escheat laws 48. Preferably, however, the consumer activates the card 47 and then the consumer uses the value on the card for purchases 49. Again, if the consumer fails to utilize the value on the card after activation, the unused value may be depleted by processor fees and state escheat laws. If a customer fails to activate a card, no value is ever placed on the card; therefore, the value cannot be depleted because there is no value to deplete. If the consumer does make purchases, information concerning those purchases may be captured and subsequently utilized by the manufacturer 40, particularly in connection with further marketing and loyalty programs.

FIG. 2C illustrates a rebate program utilizing the stored value card with load on activation feature. Thus, after the manufacture is notified of qualified rebate, the manufacturer pays only card fee to the fulfillment/processor 55. The card is then generated and sent to the consumer 46 and the consumer then activates the card 47. Should the consumer fail to activate the card, the manufacturer is never charged the rebate amount or load value. However, once the card is activated, value is loaded to the card account and the corresponding funds are held in the settlement account 58. The consumer then uses the value on the card to make purchases 49 and information on the consumer purchases may be captured 40 and may be utilized by manufacturer for further marketing and customer loyalty activities.

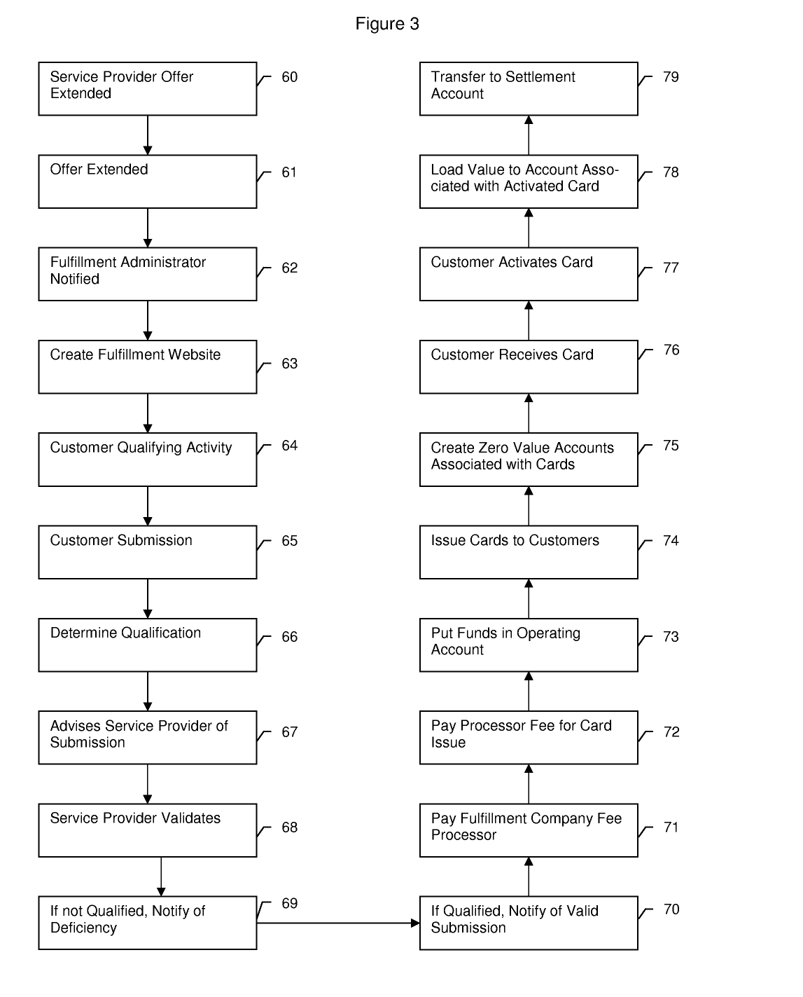

FIG. 3 illustrates an exemplary improved process for managing rebate process. The service provider such as a cable or telecommunications company determines to extend an offer to a class of customers or potential customers 60. The offer is then extended to the class of customers or potential customers as by email, postal mail, advertising service or coupon offer 61. The company also conveys details concerning the offer to the fulfillment administrator 62. The fulfillment administrator may be operational department of the service provider or independent fulfillment company. The fulfillment administrator preferably creates a redemption website to collect online redemption data from qualifying customers 63. Alternatively, the fulfillment administrator may simply develop the processes necessary to validate paper submissions of qualifying information from customers.

Customers responding to the offer make the qualifying purchase, or carry out the other qualifying activity 64. Customers submit evidence of the qualifying activity, typically either to a redemption website or postal address designated for receipt by the fulfillment administrator 65. The fulfillment administrator then validates the information submitted by the customers to determine their qualification for the rebate 66. The fulfillment administrator communicates with the service provider to advise the service provider of the processed and validated submissions 67. The service provider may have its own validation information to confirm with the fulfillment administrator's qualified submissions 68. Customers who are not qualified are preferably notified of deficiencies in their submission. If a redemption website is utilized, the rejection notification can be delivered electronically, otherwise, a postal notice may be sent 69. Preferably, customers are also notified if they have made a valid submission qualifying for the rebate 70, although such notifications may only be practical when utilizing electronic communications.

The service provider then transfers funds for several purposes. These purposes principally include compensation to the fulfillment administrator for processing customer submissions; fees to the fulfillment administrator or directly to a card issuer and processor to pay for the issuance of stored value cards to qualifying customers; and monies that will be used to fund the rebate balances. Thus, there is a transfer of funds to pay for fulfillment services 71 when a separate fulfillment company is employed, there is a transfer of funds to pay for stored value card issuance 72 either directly or indirectly to the card processor, and there is a transfer of funds to an operating account 73 that will be utilized to fund the processor's settlement account once value is loaded on stored value cards.

The card issuer/processor is notified to issue cards to qualified customers and these cards are mailed to customers 74. Upon issuance of the cards, the processor creates an account associated with each card 75. The account indicates that the value associated with the card is only nominal, and preferably $0.00, but that upon activation, the value that will be loaded into the account is the amount designated in the rebate offer, perhaps $50 or $100. Customers receive cards in the mail with instructions to activate the cards 76. Customers then go through the activation process 77 and upon activation, the $0.00 value of the account associated with the card is changed to the offer load value 78. Therefore, the customer receives the stored value card with instructions 76, the customer activates the card 77, the card processor loads the offer value 78 to the account associated with the activated cards, and funds are transferred from the operating account to the settlement account to cover the loaded values 79. In this fashion, only funds commensurate with the incentive offer applicable to the activated stored value cards is ever transferred to the settlement account, and only these funds may become subject to state escheat laws.

All publications, patents and patent documents are incorporated by reference herein as though individually incorporated by reference. Although preferred embodiments of the present invention have been disclosed in detail herein, it will be understood that various substitutions and modifications may be made to the disclosed embodiment described herein without departing from the scope and spirit of the present invention as recited in the appended claims.

We claim:

1. A method of delaying the loading of value to a stored value card until post-distribution activation comprising the steps of:
(a) offering an incentive program;
(b) distributing stored value cards to consumers qualified under the incentive program without value loaded to the cards;
(c) a consumer receiving a stored value card following an activation process;
(d) loading value to an account associated with the stored value card upon activation in step (c).

2. The method of claim 1 wherein the incentive program offers consumers an incentive value upon carrying out a qualifying activity and the incentive value is loaded to the associated account in step (d).

3. The method of claim 1 wherein the stored value cards are distributed to consumers qualified under the incentive program with only a nominal value associated with the cards.

4. The method of claim 1 wherein the stored value cards are issued by a card processor.

5. The method of claim 4 wherein the card processor maintains a settlement account associated with the stored value cards.

6. The method of claim 5 wherein funds are transferred to the settlement account commensurate with incentive values of activated stored value cards.

7. The method of claim 1 wherein a fulfillment processor validates consumers' qualifications to receive incentive values under the incentive program.

8. The method of claim 1 wherein a business offering the incentive program pays only a card fee to a fulfillment administrator and card processor upon validation of a consumer's qualifications to receive an incentive value under the incentive program.

9. The method of claim 8 wherein the business pays the incentive value to a settlement account upon the consumer following the activation process for the stored value card.

10. An incentive program comprising:
(a) a business offering incentive values to consumers carrying out a qualifying activity;
(b) a fulfillment administrator validating the consumer qualifying activity;
(c) a card processor issuing a stored value card having an associated nominal value to consumers validated by the fulfillment administrator;
(d) an activation process to be followed by consumers upon receipt of the stored value card;
(e) a settlement account associated with the stored value card that is funded with the incentive value upon a consumer following the activation process.

11. The program of claim 10 wherein the fulfillment administrator utilizes a website to receive and validate consumer qualifying activity.

12. The method of claim 10 wherein the nominal value associated with the stored value card when issued is zero.

13. The method of claim 10 wherein the business pays a card fee, separate from the incentive value, to the fulfillment administrator and card processor for validation and issuing a stored value card.

14. The method of claim 10 wherein the business provides funds to an operating account commensurate with the incentive values for the consumers who are estimated to follow the activation process.

15. The method of claim 14 wherein some consumers receiving a stored value card do not follow the activation process.

16. The method of claim 14 wherein funds are transferred from the operating account to fund the settlement account with the incentive value upon the consumer following the activation process.

17. A system for a business to utilize a stored value card in an incentive program comprising:
(a) extending an incentive offer to consumers;
(b) selected ones of the consumers carrying out an activity required to qualify for the incentive offer;
(c) qualified consumers submitting evidence of qualifying activity to a fulfillment administrator;
(d) issuing stored value cards to qualified consumers with the stored value cards having nominal associated account values;
(e) customers following an activation procedure after receipt of the stored value cards;
(f) loading incentive offer value to the stored value cards upon activation.

18. The system of claim 17 wherein commensurate funds are transferred to a settlement account associated with the stored value cards upon activation of the stored value cards.

19. The system of claim 17 wherein the fulfillment administrator utilizes a redemption website to receive consumer submissions of qualifying activity.

20. The system of claim 17 wherein evidence of qualifying activity is validated by both the fulfillment administrator and the business.
